(19) United States
(12) Patent Application Publication
(10) Pub. No.: US 2009/0006001 A1
(43) Pub. Date: Jan. 1, 2009

(54) EMPIRICAL QUANTITATIVE APPROACHES FOR PSYCHIATRIC DISORDERS PHENOTYPES

(75) Inventors: Alexander B. Niculescu, III, Indianapolis, IN (US); James B. Lohr, San Diego, CA (US)

Correspondence Address: BARNES & THORNBURG LLP, P.O. BOX 2786, CHICAGO, IL, 60690-2786, US

(73) Assignees: INDIANA UNIVERSITY RESEARCH AND TECHNOLOGY CORPORATION, Indianapolis, IN (US); THE REGENTS OF THE UNIVERSITY OF CALIFORNIA, Oakland, CA (US)

(21) Appl. No.: 12/164,090

(22) Filed: Jun. 29, 2008

Related U.S. Application Data
(60) Provisional application No. 60/947,083, filed on Jun. 29, 2007.

(51) Int. Cl. G06F 19/00

(52) U.S. Cl. 702/19

(57) ABSTRACT

Psychiatric phenotypes as currently defined are primarily the result of clinical consensus criteria rather than empirical research. A novel approach to characterizing psychiatric phenotypes is presented herein, termed PhenoChipping. A massive parallel profiling of cognitive and affective state is done with a PhenoChip composed of a battery of existing and new quantitative psychiatric rating scales, as well as hand neuromotor measures. Phenotypic overlap among, as well as phenotypic heterogeneity within, the three major psychotic disorders studied were demonstrated. Empirically derived clusterings of (endo)phenotypes and of patients serve genetic, pharmacological, and imaging research, as well as clinical practice.

### CROSS-REFERENCE TO OTHER APPLICATIONS

This application claims priority to U.S. Provisional Application No. 60/947,083 filed Jun. 29, 2007, which is hereby incorporated by reference in its entirety.

### BACKGROUND

Psychiatric phenotypes are currently characterized by consensus criteria derived primarily from clinical experience. The current criteria are categorical rather than dimensional, and not empirically derived on a consistent basis. As such, they may not entirely and accurately reflect the phenomenological reality, or have a direct correspondence with the underlying biology. There is a need for more quantitative, empirical approaches to psychiatric phenotyping, for both research and clinical purposes. The broad nature of current psychiatric phenotypical constructs is a rate-limiting step for precise and reproducible genetic research, clinical trials, and clinical practice.

The clinical overlap of phenotypes associated with major psychotic disorders such as bipolar disorder, schizoaffective disorder, and schizophrenia, on the one hand, along with the complexity of these psychiatric disorders on the other hand, points to overlapping (shared) mechanisms between disease classes, as well as heterogeneous mechanisms within a disease class. Besides overlap in clinical symptomatology and genetic studies, another body of evidence that supports the existence of shared mechanisms is that various pharmacological treatments are often successful in relieving symptoms across disorders. Conversely, certain pharmacological treatments may only be efficacious for a subgroup of people within a disease class, consistent with the existence of heterogeneity within these disorders.

Concerted attempts to be more empirical about the phenomenology of psychotic disorders, particularly bipolar disorders, have been undertaken without a concerted integration with genetic work. Personality and temperament measures have pointed to dimensional aspects of psychopathology and the existence of a continuum between normality and psychopathology. Endophenotypes may be shared in a modular fashion among various psychiatric disorders.

Gene expression profiling with microarrays (GeneChipping) is an empirical, discovery-based approach that has generated new insights in multiple fields, as well as new methodological paradigms. A microarray generally consists of thousands of nucleic acid probes attached to a glass slide. Labeled messenger RNAs, the product of gene transcription (gene expression) from a tissue that is being interrogated, are hybridized with the microarray, and the type and numbers of transcripts that stick to the chip are quantified using a specialized scanner. The readout from the scanner gives a quantitative profile of gene expression in the tissue sample analyzed. A suitable pattern recognition method is unsupervised hierarchical clustering, in which the similarity between genes determined by expression profiles across multiple conditions is measured. This approach has led to notable successes in cancer biology in terms of improved classification of tumor types, subtypes and staging, compared to classic histopathological methodologies.

The PhenoChipping approach disclosed herein provides a comprehensive method of analyzing psychiatric phenotypes. Classifying psychiatric phenotypes based on empirical data analysis may help clarify and quantify the issues of overlap and heterogeneity, and thus place the field on a more biologically relevant footing. If new subtypes can be reliably identified from empirical data analysis of patients profiled on a variety of phenotypic and genetic measures, their different neurobiological etiologies may be unraveled.

### SUMMARY

Empirically studying phenotypes in a massively parallel, quantitative, fashion (“phene” expression) for psychiatry has not been reliably performed. Phene expression may provide advantages compared to classical psychopathologic approaches, similar to those gene expression has provided for tumor classifications compared to classical histopathologic approaches. This approach is termed PhenoChipping.

Psychiatric phenotypes as currently defined are primarily the result of clinical consensus criteria rather than empirical research. A novel psychiatric analytical approach provided herein is termed PhenoChipping. As an example, a massive parallel profiling of cognitive and affective state is done with a PhenoChip composed of a battery of existing and new quantitative psychiatric rating scales, as well as hand neuromotor measures.

As an example, data from 104 subjects, 72 with psychotic disorders (bipolar disorder-41, schizophrenia-17, schizoaffective disorder-14), and 32 normal controls were used. Microarray data analysis software and visualization tools were used to investigate: 1. relationships between phenotypic items (“phenes”), including with objective motor measures, and 2. relationships between subjects. Analyses revealed phenotypic overlap among, as well as phenotypic heterogeneity within, the three major psychotic disorders studied. This approach is useful in advancing current diagnostic classifications, and suggests a combinatorial building-block structure underlies psychiatric syndromes. The use of microarray informatic tools for phenotypic analysis readily facilitates direct integration with gene expression profiling of whole blood or lymphocytes in the same individuals, a strategy for molecular biomarker identification. Empirically derived clusterings of (endo)phenotypes and of patients better serves genetic, pharmacological, and imaging research, as well as clinical practice.

A method of systematic phenotypic profiling of one or more individuals with psychiatric disorders to identify empirical relationships between phenotypic items (phenes) and the disorders includes:
(a) identifying a plurality of psychiatric phenotypic items (phenes), wherein the phenes are quantitatively measured;
(b) assigning a numerical value for one or more of the phenes; and
(c) generating a phenotypic profile for the one or more individuals with psychiatric disorders based on a statistical analysis of the association of the phenes, wherein the phenotypic profile comprises empirical relationships between phenotypic items and the disorders.

Suitable sychiatric phenotypic items (phenes) include for example, psychiatric rating scales, biomarkers, brain imaging, electroencephalography (EEG), and other neurophysiological data.

Suitable phenes include for example FIL, FIR, LVS, RVS, SFGEN, SF-36, Simplified Mood Scale (SMS), Mood, Motivdo, Mvmtactv, Thnkactv, Selfestm, Interest, Appetite, TotMood, Simplified Anxiety Scale(SAS), Anxiety, Uncertnt, Fear, Anger, TotAnxty, TOTAFFECT, SMS+SAS, PANSS Items, PANSSPOS, PANSSNEG, PANSSGEN, Depression Scales, HAM-D17, HAM-D28, Mania Rating Scale, and YMRS.

Phenes may be derived from measuring Positive and Negative Symptoms Scale (PANSS) (with a positive symptom subscale-PANSSPOS, a negative symptom subscale-PANSSNEG, and a disorganization subscale-PANSSGEN); Hamilton Rating Scale for Depression (HAM-D 17 and HAM-D 28); Young Mania Rating Scale (YMRS); Medical Outcomes Study Short Form-36 (SF-36); Total Affective State Scale (TASS); and neurophysiological motor measures (VS-velocity scaling, and FI-force instability).

Psychiatric disorders may include affective and psychotic disorders. Affective disorders include for example bipolar, depression and anxiety and the psychotic disorders include for example schizophrenia and schizoaffective disorders.

Empirical relationships between phenes may be obtained from a hierarchical clustering analysis. Numerial values assigned to one or more phenes may be normalized using z-scoring.

A method of personalizing a psychiatric treatment plan of a subject based on phenotypic profiling includes:
(a) obtaining a quantitiative psychiatric phenotypic profile of the subject comprising a plurality of psychiatric phenotypic items (phenes);
(b) comparing the phenotypic profile of the subject to one or more reference psychiatric phenotypic profiles of one or more psychiatric disorders; and
(c) selecting a psychiatric treatment plan based on the outcome of the comparison of the phenotypic profile of the patient with the reference psychiatric phenotypic profiles.

Reference psychiatric phenotypic profiles may be obtained from successful psychiatric treatments for psychiatric disorders. Some of the psychiatric phenotypic items (phenes) is selected from the group that includes phenes listed in Table II. Reference psychiatric phenotypic profiles may also include psychiatric phenotypic profiles of a plurality of subjects and clinicopathological data selected from the group consisting of age, previous personal and/or familial history of psychiatric disorder, clinical response to psychiatric disorder, and any genetic or biochemical predisposition to psychiatric illness. Association between the phenotypic profile of the subject and the reference psychiatric phenotypic profiles may be statistically significant.

A method of optimizing psychiatric drug discovery or clinical trials, the method comprising:
(a) obtaining quantitative psychiatric phenotypic data for a first set of plurality of subjects in a first clinical trial, wherein the phenotypic data comprises a plurality of psychiatric phenotypic items (phenes);
(b) obtaining clinical trial criteria data from the plurality of the subjects for a psychiatric drug;
(c) generating quantitative psychiatric phenotypic profiles comprising one or more of the psychiatric phenotypic items for one or more of the clinical trial criteria, thereby identifying one or more phenes as surrogate markers for a clinical outcome;
(d) obtaining quantitative psychiatric phenotypic data for a second set of plurality of subjects in a second clinical trial; and
(e) selecting subjects from the second set if the quantitative psychiatric phenotypic data comprises one or more phenes from the first set such that the subjects from the second set are more likely to respond to the psychiatric drug in the second clinical trial.

Sequential enriching of subjects that are more likely to respond to the psychiatric drug based on one or more of phenes or one or more of the clinical trial criteria may be performed using the phenotypic profiling approach disclosed herein.

Clinical trial criteria may include responders/non-responders and side-effects/no side-effects to a psychiatric drug of interest. Phenotypic profiles include similarity assessed using a hierarchical clustering approach. Quantitative psychiatric phenotypic profiles are useful to identify subgroups of subjects associated with a category selected from the group consisting of clinical trial outcome to a new drug, response to a certain existing clinical treatment, and associated with a biomarker or groups of biomarkers.

A method of diagnosing a psychiatric disorder in an individual includes:
(a) performing a systematic phenotypic profiling of the individual, wherein the phenotypic profiling is based on a plurality of quantitative psychiatric phenotypes;
(b) comparing the phenotypic profiling of the individual to one or more reference phenotypic profiles for one or more psychiatric disorders; and
(c) diagnosing the psychiatric disorder if the phenotypic profiling of the individual is statistically similar to one of the reference phenotypic profiles.

Phenotypic profiling may be based on quantitative measurements obtained through a questionnaire or through a clinical examination or by measurements of biomarkers in bodily fluids.

### BRIEF DESCRIPTION OF THE DRAWINGS

FIG. 1 shows Total Affective State Scale (TASS). 1a. Example of TASS item-Thinking Activity. How high is the amount of mental energy and thinking activity going on in one's mind right now? Compare to the most slowed down one ever remembers one's thinking being, and compared to the most alert and fast one ever remembers one's thinking being. 1b. Results of measurements using TASS. 1c. Total Affective State Scale—correlation with HAM-D28.

FIG. 2 illustrates Venn diagrams of the differentially changed phenes in bipolar disorder, schizophrenia and schizoaffective, compared with controls. A t-test was used to determine significance (P-value<0.05). (A) Representation of the phenes that were significantly increased compared to normal controls. (B) Representation of the phenes that were significantly decreased compared to normal controls.

FIG. 3 shows clustering of phenes: overlap across psychotic disorders. Two-way hierarchical clustering of the disease groups and 25 phenes based on the Cohen's d effect size values for each phene. All effect sizes were calculated comparing the individual disease groups with the normal controls. Each row represents a phene, while each column represents a disease group. Red and blue indicate effect sizes (expression levels) respectively above and below zero, according to the color scale shown at the bottom. Values that are shown on the dendrogram, represent the branch distance, which was determined by the standard correlation similarity measure feature in GeneSpring. Disease groups are listed as BAD for bipolar affective disorder; SZ for schizophrenia; and SZA for schizoaffective.

FIG. 4 shows clustering of subjects: heterogeneity within individual psychotic disorders. Two-way hierarchical clustering of all subjects and 25 phenes based on the Z score for each phene. All individual effect sizes were calculated by comparing each individual subject's phenes with the averages of the normal controls.

### DETAILED DESCRIPTION

As part of a comprehensive phenotypic profiling (PhenoChipping) approach, both subjective measures (quantitative answers to questions about mood, anxiety, cognition) and objective measures (neurophysiology, imaging, gene expression, biochemical assays) were analyzed. New correlations and biomarkers may be revealed by data mining of integrated datasets. Objective phenotypic measurements frequently used include neurophysiology (EEG, neuromotor measures) and brain imaging (fMRI, PET). Hand neuromotor measures, in particular, are easy to administer and deploy, which makes them attractive for large scale field studies. They engage fundamental fronto-striatal circuits regulating limbic and neuromotor behavior, which may have been recruited also for higher mental functions by evolution. Correlations between motor measures and clinical parameters have been reported in both bipolar disorders and schizophrenia, including in never medicated schizophrenia; moreover, looking at right hand vs. left-hand measures may provide a window into brain hemispheric lateralization of pathology. The relationship between cognitive impairment and motor abnormalities remains an important area for further research. Moreover quantitative hand neuromotor measures are predictive of antidepressant non-response.

A method of systematic phenotypic profiling of one or more individuals (e.g., patients undergoing treatment) with psychiatric disorders to identify empirical relationships between phenotypic items (phenes) and the disorders includes:
(a) identifying a plurality of psychiatric phenotypic items (phenes), wherein the phenes are quantitatively measured and/or capable of being normalized or adjusted using a standard statistical tool;
(b) providing a discrete numerical value for one or more of the phenes based on the measurements; and
(c) generating a phenotypic profile (e.g., by hierchical clustering) for the one or more individuals with psychiatric disorders based on a statistical analysis of the association of the phenes, wherein the phenotypic profile comprises empirical relationships between phenotypic items and the disorders.

Suitable sychiatric phenotypic items (phenes) include for example, psychiatric rating scales, biomarkers, brain imaging, electroencephalography (EEG), and other neurophysiological data that can be obtained through a questionnaire, clinical examination, biochemical analysis including invasive and non-invaisve procedures.

Suitable phenes for phenotypic profiling include but are not limited to for example FIL, FIR, LVS, RVS, SFGEN, SF-36, Simplified Mood Scale (SMS), Mood, Motivdo, Mvmtactv, Thnkactv, Selfestm, Interest, Appetite, TotMood, Simplified Anxiety Scale(SAS), Anxiety, Uncertnt, Fear, Anger, TotAnxty, TOTAFFECT, SMS+SAS, PANSS Items, PANSSPOS, PANSSNEG, PANSSGEN, Depression Scales, HAM-D17, HAM-D28, Mania Rating Scale, and YMRS.

Phenes may be derived from measuring scales that are not limited to Positive and Negative Symptoms Scale (PANSS) (with a positive symptom subscale-PANSSPOS, a negative symptom subscale-PANSSNEG, and a disorganization subscale-PANSSGEN); Hamilton Rating Scale for Depression (HAM-D 17 and HAM-D 28); Young Mania Rating Scale (YMRS); Medical Outcomes Study Short Form-36 (SF-36); Total Affective State Scale (TASS); and neurophysiological motor measures (VS-velocity scaling, and FI-force instability).

Psychiatric disorders may include both affective and psychotic disorders. Affective disorders include for example bipolar disorder (high and low mood), depression and anxiety and the psychotic disorders include for example schizophrenia and schizoaffective disorders. Other characterization and classifications of psychiatric disorders as they become available are also suitable.

Empirical relationships between phenes may be obtained from a hierarchical clustering analysis. Numerial values assigned to one or more phenes may be normalized using z-scoring or any other standard statistical normalization procedure.

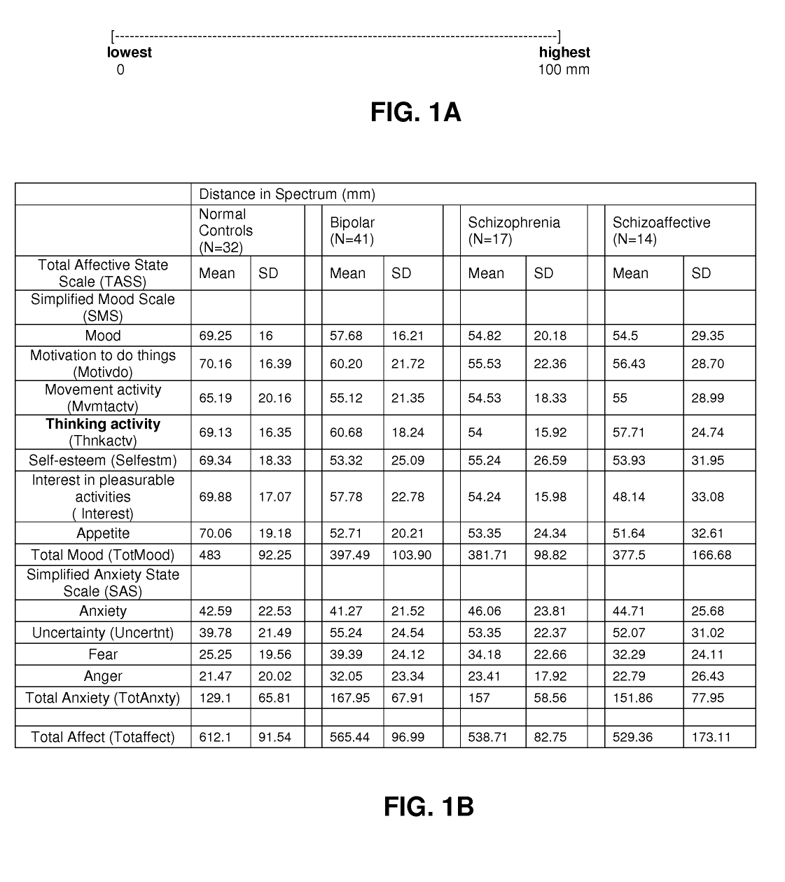

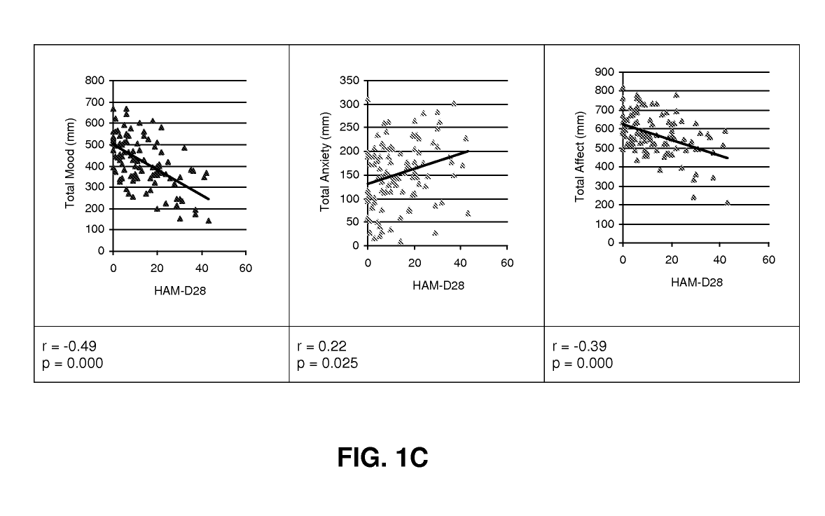

A method of personalizing a psychiatric treatment plan based on phenotypic profiling for a patient suspected of suffering from a psychiatric disorder includes:
(a) obtaining a quantitiative psychiatric phenotypic profile (e.g., Table II, FIG. 1B) of the subject comprising a plurality of psychiatric phenotypic items (phenes) through questionnaires or clinical examination or testing or any other procedure or from a previous examination report;
(b) comparing the phenotypic profile of the subject to one or more reference psychiatric phenotypic profiles that are preexisting based on successfully treated patients for one or more psychiatric disorders; and
(c) selecting a psychiatric treatment plan based on the outcome of the comparison of the phenotypic profile of the patient with the reference psychiatric phenotypic profiles.

Comparing the profile of the subject with a reference profile may be performed using any reliable method. For example, the total number of phenes that are present or absent can be compared. In another way, a statistical comparison can be performed using ANOVA to determine whether the two profiles are statistically similar. In another way, if a graphical presentation (e.g., color coded) is generated as part of the analysis, visual comparisons of the two profiles can also be performed by a psychiatrist or a clinician. Thus, the mode of comparison is not limiting as long as any reliable method is adopted to compare the phenotypic analysis of a patient to be treated with the phenotypic analysis of those patients who were successfully treated for that disorder.

Reference psychiatric phenotypic profiles may be obtained from successful psychiatric treatments for psychiatric disorders. Reference psychiatric phenotypic profiles may be obtained from subjects who were not fully treated but responded well or exhibited minimal side-effect. Thus, the reference profiles can be tailored towards any desirable outcome such as responsiveness, side-effects, symptomatic relief, and therapeutic cure. Some of the psychiatric phenotypic items (phenes) is selected from the group that includes phenes listed in Table II. Reference psychiatric phenotypic profiles may also include psychiatric phenotypic profiles of a plurality of subjects and clinicopathological data selected from the group consisting of age, previous personal and/or familial history of psychiatric disorder, clinical response to psychiatric disorder, and any genetic or biochemical predisposition to psychiatric illness. Association between the phenotypic profile of the subject and the reference psychiatric phenotypic profiles may be statistically significant.

A method of optimizing or psychiatric drug discovery or enriching clinical trials includes:
(a) obtaining quantitative psychiatric phenotypic data from a first set of plurality of subjects in a first clinical trial, wherein the phenotypic data includes a plurality of psychiatric phenotypic items (phenes), which will be used to enrich the subjects in a subsequent clinical trial;
(b) obtaining clinical trial criteria data such as (responsiveness and side-effects) from the plurality of the subjects for a psychiatric drug as part of the clinical trial data collection;
(c) generating quantitative psychiatric phenotypic profiles comprising one or more of the psychiatric phenotypic items for one or more of the clinical trial criteria, thereby identifying one or more phenes as surrogate markers for a clinical outcome;
(d) obtaining quantitative psychiatric phenotypic data for a second set of plurality of subjects in a second clinical trial to use this data as a screen to identify patients for a second clinical trial; and
(e) selecting or identifying subjects from the second set if the quantitative psychiatric phenotypic data comprises one or more surrogate phenes from the first set such that the subjects from the second set are more likely to respond to the psychiatric drug in the second clinical trial.

A surrogate marker or surrogate phene is a measure of effect of a certain treatment that may correlate with a real endpoint but doesn't necessarily have a guaranteed relationship. A surrogate marker is intended to substitute for a clinical endpoint. Surrogate markers are used when the primary endpoint is not practical or undesired or when the number of events is relatively small, thus making it impractical to conduct a clinical trial to gather a statistically significant number of endpoints. Generally, a surrogate marker is a laboratory measurement of biological activity within the body that indirectly indicates the effect of treatment on disease state.

Sequential enriching of subjects that are more likely to respond to the psychiatric drug based on one or more of phenes or one or more of the clinical trial criteria may be performed using the phenotypic profiling approach disclosed herein.

Clinical trial criteria may include responders/non-responders and side-effects/no side-effects to a psychiatric drug of interest. Any other suitable criteria can be included. Phenotypic profiles include similarity assessed using a hierarchical clustering approach. Quantitative psychiatric phenotypic profiles are useful to identify subgroups of subjects associated with a category selected from the group consisting of clinical trial outcome to a new drug, response to a certain existing clinical treatment, and associated with a biomarker or groups of biomarkers.

A method of diagnosing a psychiatric disorder or choosing a particular treatment plan for an individual includes:
(a) performing a systematic phenotypic profiling of the individual by obtaining phenotypic data for a plurality of quantitative psychiatric phenotypes;
(b) comparing the phenotypic profiling (or simply one or more phenotypic item) of the individual to one or more reference phenotypic profiles (or simply one or more phenotypic item) for one or more psychiatric disorders; and
(c) diagnosing the psychiatric disorder or choosing a treatment option if the phenotypic profiling of the individual is statistically similar to one of the reference phenotypic profiles.

Phenotypic profiling may be based on quantitative measurements obtained through a questionnaire or through a clinical examination or by measurements of biomarkers in bodily fluids.

The PhenoChip used in this report includes a battery of psychiatric rating scales (for psychosis, well-being and mood) and one developed affective scale, together with right and left hand neuromotor measures, all quantitative in nature. How responses to questionnaires that reflect an internal subjective experience might correlate with objective neuromotor measures were observed.

Affective abnormalities are an integral part of major psychotic disorders, yet they are often overlooked and not tested for in patients with psychosis, as opposed to patients with mood disorders. A simple-minded, quantitative, visual analog scale to assess affective state (Total Affective State Scale-TASS) was developed, based on combining and placing on a continuum the DSM-IV criteria for depression, mania and anxiety. From a pragmatic standpoint, it was reasoned that there was a higher likelihood of uncovering new phenomenology in an area that has been less explored (mood in psychosis). More generally, the interdependence of cognition and mood was analyzed.

Each of the 11 individual items in TASS was placed on the PhenoChip, along with the Total Mood subscale, Total Anxiety subscale, and overall Total Affect composite scale (for a total of 14 probes), and placed on it only the composite scales for the 11 other rating instruments (including four neuromotor measures, two for each hand). Thus, the prototype PhenoChip had 25 probes in total. While being comprehensive, it is biased towards the finer grained detection of affective phenomenology. Moreover, in addition to having the current standard rating scales for psychosis and mood (such as PANSS, HAM-D, YMRS) a variety of other rating scales can be chosen or added.

Phenes that were significantly different between each disease group and normal controls are shown in Table II, both with effect size data and t-test data. An effect size of greater than 0.50 is considered medium to high, and significant. 22 phenes were identified in bipolar subjects (11 increased and 11 decreased), 16 phenes in schizophrenic subjects (10 increased and 6 decreased) and 13 phenes in schizoaffective subjects (8 increased and 5 decreased) that were significantly changed (p<0.05).

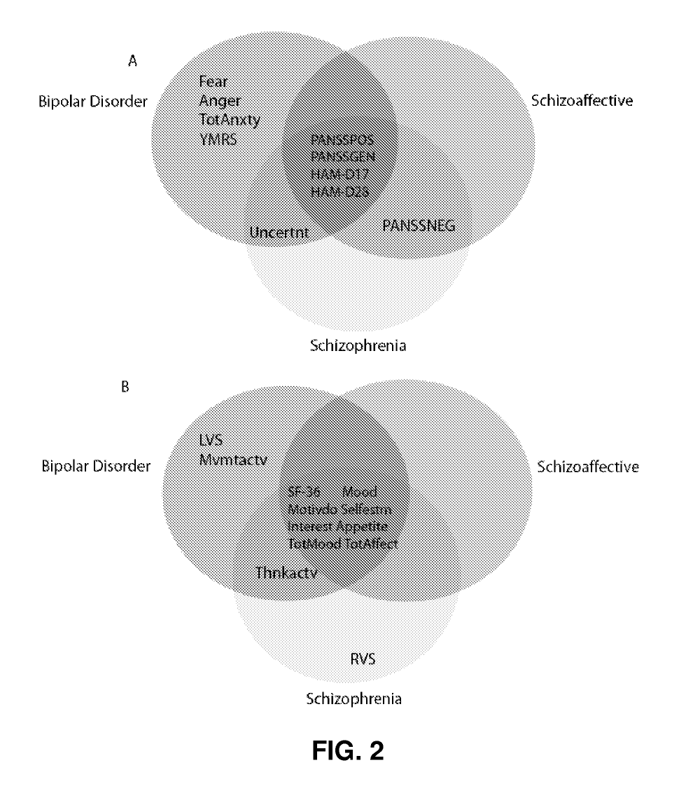

Venn diagram analysis: Venn diagrams based on the differentially changed phenes in bipolar disorder, schizophrenia, and schizoaffective disorder, compared with controls, are shown in FIG. 2. FIG. 2a represents the phenes that were significantly increased, and FIG. 2b represents the phenes that were significantly decreased. Several of the differentially expressed phenes were shared between the three psychotic disorders. These shared phenes included four that were increased (PANSSPOS, PANSSGEN, HAM-D17, HAM-D28) and eight that were decreased (SF-36, Mood, Motivdo, Selfestem, Interest, Appetite, Totmood, Totaffect). These results demonstrate that the three major psychotic disorders share phenotypic characteristics. Interestingly, bipolar disorder had six uniquely changed phenes: Fear, Anger, Totanxty, and YMRS were increased; LVS and Mvmtactv were decreased.

The phenes were classified into 3 categories, from less specific to more specific. Category I phenes are changed in all three psychotic disorders in the sample, compared to normal controls. Category II phenes are changed in two out of the three psychotic disorders, compared to normal controls. Category III phenes are just changed in one disorder, compared to controls.

The Category I phenes increased in all three psychotic disorder groups are: PANSSPOS, PANSSGEN, HAM-D17 and HAM-D28. They have to do with positive symptoms psychosis, disorganization, and depression. The Category I phenes, decreased in all three psychotic disorders groups, are SF-36, Mood, Motivdo, Selfestem, Interest, Appetite, TotMood, TotAffect. They have to do with well-being and mood. These results indicate that the three groups of patients, at the time of PhenoChipping, were overall in a more depressed, psychotic, low well being state compared to normal controls. Furthermore, the results suggest that the areas of endophenotypic and neurobiological overlap common to all three psychotic disorders have to do with both cognition and mood.

The Category II phene increased in common in bipolar disorder and schizophrenia is Uncertnt (Uncertainty), and decreased in common in these two disorders is Thnkactv (Thinking Activity). These results indicate that these two groups of patients, at the time of PhenoChipping, were overall in a state characterized by slow thinking, perhaps in part as a paralyzing consequence of high uncertainty. Furthermore, they indicate that an area of endophenotypic and neurobiological overlap between bipolar disorder and schizophrenia has to do with thinking activity and decision-making. The Category II phene increased in common in schizophrenia and schizoaffective disorder is PANSSNEG. This result indicates that these two groups of patients, at the time of the PhenoChipping, were experiencing more negative symptoms than normal controls, and that negative symptoms may be a core endophenotypic and neurobiological feature of schizophrenia spectrum disorders- or a medication side-effect of typical antipsychotics, which are used preponderantly in these two groups of psychotic disorders, compared to bipolar disorder.

The Category III phenes increased only in bipolar disorder patients were Fear, Anger, TotAnxty, MRS. They have to do with anxiety, irritability and activation. The Category III phenes decreased only in bipolar disorder patients were LVS (Left Velocity Scaling) and Mvmtactv (Movement Activity). They have to do with right hemisphere activity, and overall energy to move. These results indicate that the bipolar patients, at the time of the PhenoChipping, were in an irritable, psychomotorly retarded state, having to do preferentially with their right hemisphere. Furthermore, they indicate that an area of endophenotypic and neurobiological specificity for bipolar disorders compared to schizophrenia spectrum disorders has to do with anxiety and irritability. An objective neuromotor measure, LVS (Left hand Velocity Scaling), having to do with right hemisphere activity, could potentially be used as a behavioral biomarker for bipolarity and to monitor treatment response.

The Category III phene decreased only in schizophrenia patients is RVS (Right hand Velocity Scaling). It has to do with left hemisphere activity. This result indicates that the schizophrenic patients, at the time of the PhenoChipping, were in a psychomotorly retarded state, having to do preferentially with their left hemisphere. Furthermore, they suggest that an area of endophenotypic and neurobiological specificity for schizophrenia, compared to psychotic disorders with a major affective component, has to do with left hemisphere function. An objective neuromotor measure, RVS, having to do with left hemisphere activity, could potentially be used as a behavioral biomarker for schizophrenia and to monitor treatment response.

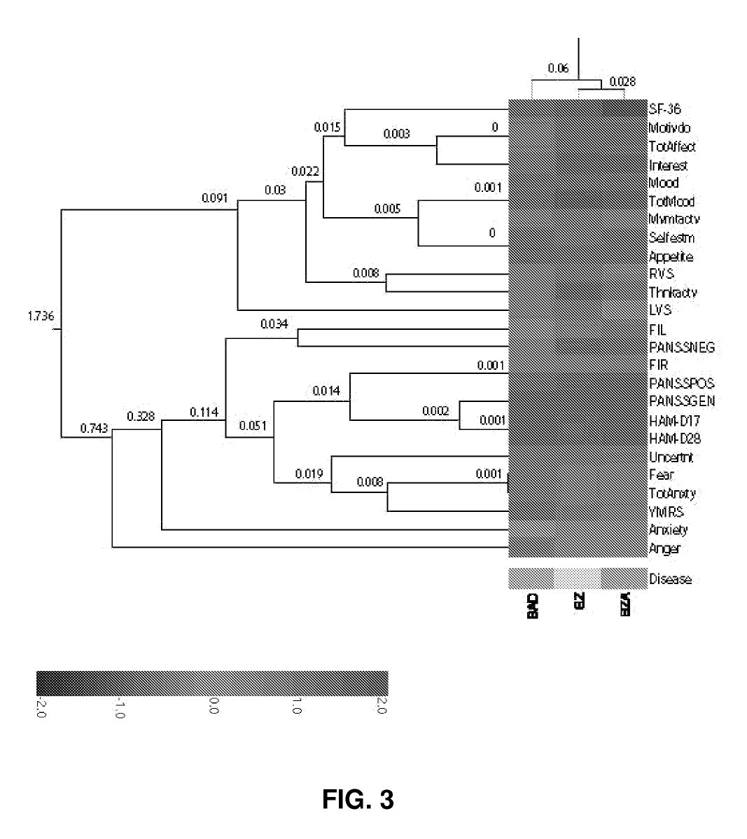

Clustering of phenes (FIG. 3): Two-way unsupervised hierarchical clustering of the three diagnostic groups was first applied, based on the average effect size for all phenes across the three groups. Results are displayed in a color-coded “heat map” (FIG. 3), where diagnostic groups are ordered on the horizontal axis and phenes on the vertical axis on the basis of similarity of their effect sizes. Of interest, expression patterns are fairly similar across the three diagnostic groups, with schizophrenia and schizoaffective more similar to each other than to bipolar disorder.

The phenes grouped into two main clusters: phenes that increased in expression compared to normal controls (FIL, PANSSNEG, FIL, PANSSPOS, PANSSGEN, HAM-D17, HAM-D28, Uncertnt, Fear, TotAnxty, YMRS, Anxiety, Anger) and phenes that decreased in expression compared to normal controls (SF-36, Motivdo, TotAffect, Interest, Mood, TotMood, Mvmtactv, Selfestm, Appetite, RVS, Thnkactv, LVS). All of the well-being and mood measures, with the exception of YMRS, were found to be decreased across all three disorders. However, HAMD, Fear and Anger were increased. At the time of PhenoChipping, the subjects were overall in a state of irritable dysphoria. The score on YMRS may be measuring the activation aspect of this state rather than true (hypo) mania.

Examples of phenes that clustered together most closely across all three psychotic disorders groups, in our preliminary results so far, are: Motivation and Total Affect, Self-esteem and Appetite, Fear and Total Anxiety, RVS (Right hand Velocity Scaling) and Thinking Activity, FIR (Force Instability of Right hand)and PANSSPOS, FIL (Force Instability Left hand) and PANSSNEG.

A non-hypothesis driven, discovery-based approach thus uncovers new empirical relationships between phenotypic items, which are of high neurobiological interest. One such result is the relationship between motivation to do things and affective state. Another one is the relationship between self-esteem and appetite, with clinical implications for abnormal weight changes in these and related disorders.

This approach also uncovers relationships between objective phenes (hand neuromotor measures) and subjective phenes. One such result is the relationship between Right Velocity Scaling and Thinking Activity, suggesting a possible left hemispheric dominance of the neurobiological correlate of this measured phenotype. This may have clinical implications for using left-hemisphere stimulation, through methods such as TMS (Transcranial Magnetic Stimulation), for patients with sluggish thinking, as seen in depression or negative symptoms schizophrenia.

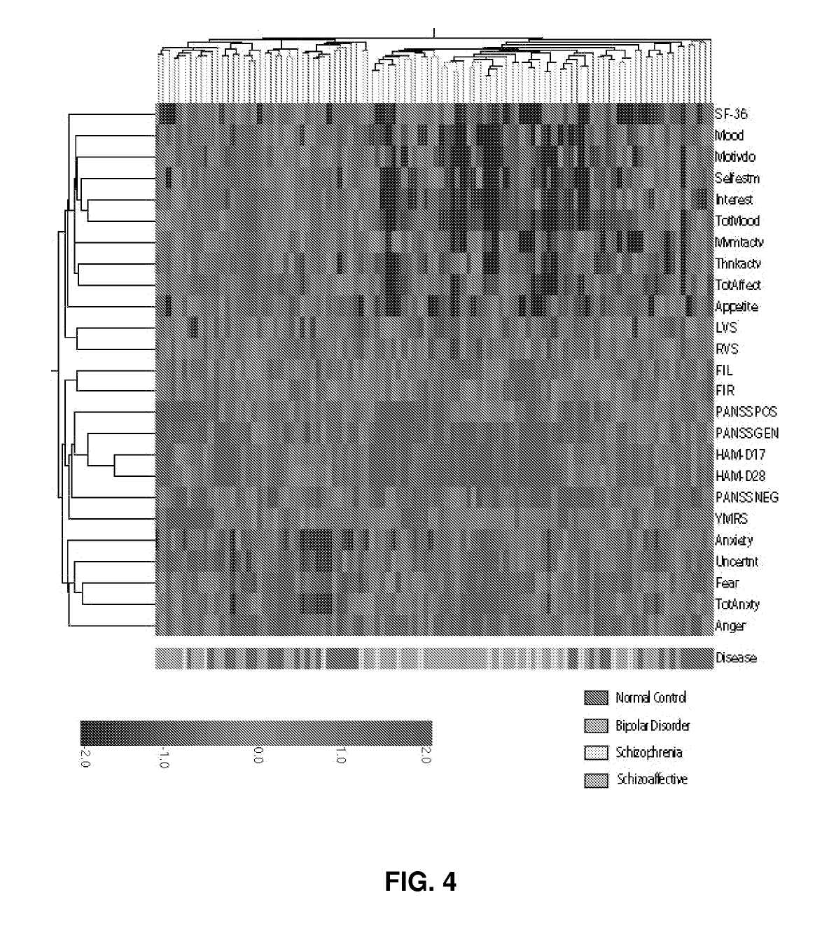

Clustering of subjects (FIG. 4): Next, unsupervised two-way hierarchical clustering was applied to all of the 104 subjects, based on the Z scores for all the phenes across all of the subjects. Results are displayed in FIG. 4 as a color-coded heat map, where the subjects are ordered on the horizontal axis and phenes are ordered on the vertical axis on the basis of similarity of their individual effect sizes. The four major diagnostic groups as established by SCID (normal controls, bipolar, schizophrenia, schizoaffective) fail to cluster together in four distinct groups. The fact that subjects from different diagnostic groups are interspersed speaks to the overlap among current diagnostic classifications (including normal controls), as well as to their internal heterogeneity. Artificial boundaries between control and affected subjects may become blurred when dimensional rather than categorical approaches are used, and should provide a rationale and impetus for population QTL studies in psychiatric genetics.

The clustering of this set of individual subjects leads to pairs of highly similar subjects (pseudo-twins) from different diagnostic groups that share more characteristics with each other than with subjects in their own diagnostic group. This methodology proves useful in pairing subjects for genetic, pharmacological, biomarker and imaging studies. Moreover, clinically, it identifies subjects that may respond similarly to treatments, and should be treated psychiatrically in the same way.

An empirical approach to characterizing psychiatric phenotypes, termed PhenoChipping is presented herein. The approach includes a massive parallel sampling of cognitive and affective state, employing paradigms and analysis tools from the microarray gene expression field. Data revealed overlap among, as well as heterogeneity within, the three major psychotic disorders studied, for example: bipolar disorder, schizophrenia, and schizoaffective disorder. Moreover, the use of hand neuromotor measures has provided preliminary evidence supportive of hemispheric lateralization of cognition and mood, as well as leads for objective behavioral biomarker development. Multiple PhenoChipping measurements, at different timepoints, can be performed that addresses state vs. trait issues, by looking at how phenes change over time. The results may reflect, at least in part, a combination of medication (side) effects and underlying disease phenomenology. This may be present for hand motor measures in patients on antipsychotic medication (for the Velocity Scaling measure), or mood stabilizing medications (for the Force Instability measure). PhenoChipping of first degree relatives who do not have overt clinical illness, are unmedicated, but may have (endo)phenotypic abnormalities, can be performed.

PhenoChipping, is useful to understand the phenotypic structure of major psychiatric disorders. Data documents both overlap among, and heterogeneity within, the three major psychiatric disorder studied, and suggests a combinatorial building-block (Lego-like) structure underlies these psychiatric syndromes.

An immediate practical application for an integrative strategy is in pharmacogenomics; a second is in the identification of peripheral behavioral and molecular biomarkers of illness (e.g., surrogate markers). A better understanding of major psychiatric disorders such as bipolar disorder, schizophrenia, and schizoaffective disorder, will lead to more targeted treatments, with improved efficacy and decreased side-effects. This has an impact on patient health, well-being, quality of life, and independent functioning. Moreover, early diagnosis and intervention may prevent the full-blown development of illness in genetically susceptible individuals.

“PhenoChipping” refers to a novel, broadly applicable empirical approach to quantitatively analyze/characterize various phenotypes by assigning numerical values to one or more phenes, thereby developing structural relationships among the various phenotypes. This approach is applied as a proof of principle to psychiatric disorders, uncovering novel structural relationships between various phenotypes, including cognitive and affective states for one or more psychiatric disorders. This approach can also be used to profile individuals in a population/group, uncovering subgroups of individuals that share similar phenotypic profiles. It is also demonstrated using psychiatric disorder patients the classifying power of this approach. These phenotypic measures can readily be integrated with other quantitative measures (such as for example, genetic, genomic, imaging and EEG measures), facilitating discovery of biomarkers related to specific disease states and responses to various medications or other environmental factors.

In an embodiment, methods to build a collection of blood samples from the subjects that are PhenoChipped, for repeated mining by studies integrating genetics and genomics with the phenomics are disclosed.

In an embodiment, subjects in a clinical trial for a psychiatric drug undergo a phenotypic profiling for one or more of the phenotypic items (phenes). These phenes include any psychiatric phenotype that is quantitatively measured or those for which quantitative values can be assigned. Assigning quantitative values may include normalizing to account for the variability in the magnitude of various measures. An example for normalizing quantitative values is z-scoring described herein. These phenes can include questionnaire with a variety of psychological assessments, brain imaging data (such as Functional Magnetic Resonance Imaging-fMRIpositron emission tomography-PET scans), neurophysiological data (such as hand neuromotor measures, EEG), blood biomarkers including gene expression levels and SNPs, and any other data that is or can be associated with a psychiatric disorder. The phenotypic profiling data obtained from the subjects is subject to a statistical association analysis, e.g., hierarchical clustering analysis with one or more clinical trial criteria. These clinical trial criteria include for example, efficacy (responders and non-responders) and side-effects (presence or absence of side-effects). Any suitable clinical trial criteria for psychiatric drugs are applicable for the association analysis. One of the goals for the comparison is to obtain clusters or subsets of phenes that are closely associated with a particular clinical trial criteria, and that can act as surrogate markers for enrollment in subsequent clinical trials as well as for clinical treatment decisions once a drug is approved and in clinical use. For example, the phenotypic profiling approaches described herein identify a subset or cluster of phenes that are associated with the group of subjects who respond well to a particular drug or a treatment plan. Treatment plan includes for example, dosage, duration, combination therapy with one or more drugs, and alternate therapies for psychiatry. Depending on the number of subjects, upon phenotypic profiling, one or more phenes or a subset of phenes are identified to be associated with certain clinical trial criteria, e.g., responsiveness to a psychiatric drug. Following such a classification or clustering of phenes, the phenotypic profiling data and surrogate markers are then used to screen subjects for enrollment in a subsequent clinical trial wherein the subject pool in enriched such that the subjects are more likely to respond or exhibit reduced side-effects to the drug being evaluated. Similar methodology is implemented by a clinician or a clinic to increase the success rate of treating patients with a particular drug or a particular treatment plan.

In an embodiment, a clinician or a clinic obtains phenotypic data from the patients to develop phenotypic profiling over time with repetitive enriching of the data to better predict which drug or treatment plan would work for a future patient. For example, a database that includes a variety of phenotypic items disclosed herein and those phenotypic items that are readily known or available to a psychiatrist is maintained and updated with information regarding efficacy, responsiveness, side-effects for one or more psychiatric drugs. A clinic or a clinician then accesses the database to identify a particular drug or a treatment plan for a patient who has been phenotypically profiled with one or more phenotypic items (phenes) present in the database. This selection of a particular choice of drug or treatment plan based on quantitative empirical analysis enhances the likelihood of success for treating a psychiatric patient.

In an embodiment, the phenotypic profiling is used to identify new psychiatric markers. For example, using the PhenoChipping approach described herein, new biomarkers (e.g., SNPs, gene expression in blood or other tissues, QTL and any genetic variation) are identified that are associated with one or more of the phenes tested. Thus, in an embodiment phenotypic profiling is a tool to identify underlying genetic markers that are associated with a disorder, phenotype, or response to a psychiatric drug.

In an embodiment, phenotypic profiling data obtained from a first clinical trial (e.g., termed as “pre-existing” profile or reference profile) is used to screen for subjects to be enrolled in a second clinical trial such that the subjects in the second clinical trial have a better chance of responding well or exhibiting less side-effects to a drug that is being evaluated. Such enrichment of subjects may be performed iteratively so that the subsequently enrolled patients for a clinical trial have an increased likelihood of responding to the drug or experience lesser side-effects.

As used herein, reference psychiatric phenotypic profile means a pre-existing phenotypic expression profile to which a phenotypic profile is compared for a clinical outcome of interest. The reference psychiatric phenotypic profile is generally developed for example by obtaining quantitative data for a plurality of phenes (namely about 5, 10, 15, 20, 25, 30, 35, 40, 45, or 50) for one or more psychiatric disorders from a plurality of individuals. For example, a reference psychiatric phenotypic profile offers a subset of phenes whose numerical values predict the likelihood of success for a particular drug or treatment plan for a particular patient, whose phenotypic profile includes one or more phenes present in the reference psychiatric phenotypic profile. For example, a reference psychiatric phenotypic profile is obtained from patients who have been successfully treated with a particular drug or a treatment plan previously.

The phrase “clinically positive outcome” refers to biological or biochemical or physical or physiological responses to treatments or therapeutic agents that are generally prescribed for that condition compared to a condition would occur in the absence of any treatment. A “clinically positive outcome” does not necessarily indicate a cure, but could indicate a lessening of symptoms experienced by a subject.

The terms “marker” and “biomarker” are synonymous and as used herein, refer to the presence or absence or the levels of nucleic acid sequences or proteins or polypeptides or fragments thereof to be used for associating or correlating a phenotypic state. A biomarker includes any indicia of the level of expression of an indicated marker gene. The indicia can be direct or indirect and measure over- or under-expression of the gene given the physiologic parameters and in comparison to an internal control, normal tissue or another phenotype. Nucleic acids or proteins or polypeptides or portions thereof used as markers are contemplated to include any fragments thereof, in particular, fragments that can specifically hybridize with their intended targets under stringent conditions and immunologically detectable fragments. One or more markers may be related. Marker may also refer to a gene or DNA sequence having a known location on a chromosome and associated with a particular gene or trait. Genetic markers associated with certain diseases or for pre-disposing disease states can be detected in the blood and used to determine whether an individual is at risk for developing a disease. Levels of gene expression and protein levels are quantifiable and the variation in quantification or the mere presence or absence of the expression may also serve as markers. Using proteins/peptides as biomarkers can include any method known in the art including, without limitation, measuring amount, activity, modifications such as glycosylation, phosphorylation, ADP-ribosylation, ubiquitination, etc., imunohistochemistry (IHC).

A variety of clustering methods are available for analysis. See for example, Shamir & Sharan (2002) Algorithmic approaches to clustering gene expression data. In Current Topics In Computational Molecular Biology (Edited by: Jiang T, Xu Y, Smith T). 2002, 269-300; Tamames et al., (2002): Bioinformatics methods for the analysis of expression arrays: data clustering and information extraction, J Biotechnol, 98:269-283.

“Therapeutic agent” or “drug” means any agent or compound useful in the treatment, prevention or inhibition of a psychiatric disorder.

The term “condition” refers to any disease, disorder or any biological or physiological effect that produces unwanted biological effects in a subject.

The term “diagnosis”, as used in this specification refers to evaluating the type of disease or condition from a set of marker values and/or patient symptoms where the subject is suspected of having a disorder. This is in contrast to disease predisposition, which relates to predicting the occurrence of disease before it occurs, and the term “prognosis”, which is predicting disease progression in the future.

The term “consisting essentially of” as used herein relate to a subset or group or cluster of phenes that account for or associated with the disorder of interest.

The term “correlating,” as used in this specification refers to a process by which phenotypic items (phenes) are associated to a particular disease state, e.g., mood disorder. In general, identifying such correlation or association involves conducting analyses that establish a statistically significant association- and/or a statistically significant correlation between the presence (or a particular level) of a phene or a combination of phenotypic items and the disorder e.g., response to a drug or side-effects to a drug in the subject. An analysis that identifies a statistical association (e.g., a significant association) between the phenotypic items or combination of phenotypic items and clinically relevant criteria establish a correlation between the presence of the marker or combination of phenotypic items in a subject and the outcome being analyzed.

### Materials and Methods

Demographics and subject enrollment: A sample of 104 subjects were collected, consisting of 41 subjects with bipolar disorder, 17 with schizophrenia, 14 with schizoaffective disorder, and 32 without significant psychiatric illness (normal controls), determined by the Structured Clinical Interview for the DSM-IV Axis I Disorders, Clinician Version (SCID-I).

Subjects included men and women over 18 years of age. A demographic breakdown is shown in Table I. Subjects were recruited from the general population, the patient population at the Veterans Affairs San Diego Healthcare System and the University of California at San Diego, as well as various facilities that serve people with mental illnesses in San Diego County. The subjects were recruited largely through referrals from care providers, through the use of brochures left in plain sight in public places and mental health clinics, and through word of mouth. Subjects were excluded if they had significant medical or neurological illness or had evidence of active substance abuse or dependence. All subjects understood and signed informed consent forms before assessments began.

Administration of the PhenoChip: Subjects completed diagnostic assessments (SCID), and then were PhenoChipped. The PhenoChip used consisted of a battery of: 1) existing psychiatric rating scales: Positive and Negative Symptoms Scale (PANSS) (with a positive symptom subscale-PANSSPOS, a negative symptom subscale-PANSSNEG, and a disorganization subscale-PANSSGEN) (Kay et a., (1987) The positive and negative syndrome scale (PANSS) for schizophrenia. Schizophr Bull 13(2):261-76), Hamilton Rating Scale for Depression (HAM-D 17 and HAM-D 28) (Hamilton (1960). A rating scale for depression. J Neurol Neurosurg Psychiatry 23:56-62.) (Hamilton (1980). Rating depressive patients. J Clin Psychiatry 41(12 Pt 2):21-4.), Young Mania Rating Scale (YMRS) (Young et al., (1978) A rating scale for mania: reliability, validity and sensitivity. Br J Psychiatry 133:429-35), Medical Outcomes Study Short Form-36 (SF-36) (Ware et al., (1996), Differences in 4-year health outcomes for elderly and poor, chronically ill patients treated in HMO and fee-for-service systems. Results from the Medical Outcomes Study. Jama 276(13):1039-47.); 2) a new visual-analog scale: Total Affective State Scale (TASS) (Caligiuri et al., (2006), Striatopallidal regulation of affect in bipolar disorder. J Affect Disord 91(2-3):235-42.), as well as 3) hand neuromotor measures: VS-velocity scaling, FI-force instability (Caligiuri et al., (1998), Scaling of movement velocity: a measure of neuromotor retardation in individuals with psychopathology. Psychophysiology 35(4):431-7.).

The battery was administered in one of three predetermined counterbalanced orders. Subjects were paid for their participation. Testers were not blind to the subject's diagnosis, but were not aware of the study hypotheses or the approach that would be used for empirical data analysis.

Visual analog scale-Total Affective State Scale (TASS): The newly developed visual analog scale, the Total Affective State Scale (TASS), quantifies mood and anxiety symptoms at the time of administration (FIG. 1). It has a mood subscale and an anxiety subscale. The seven-item mood subscale (Simplified Mood State Subscale-SMS) is based on: a) combining the DSM-IV criteria for depression and mania, and b) placing the items on a continuum. The four-item anxiety subscale (Simplified Anxiety State Subscale-SAS), quantifies feelings of uncertainty, fear and anger. The advantages of TASS, and the reasons for using it, are that: 1) it quantifies state, 2) it measures phenotypes on a continuum, from normal to pathology, 3) it is self-rated, which facilitates administration and ease of use.

For example in the TASS rating, the following were measured based on a scaling shown in FIG. 1A for the various phenotypes: mood (Worst/Most Depressed - - - Best/Least Depressed); motivation to do things (Least Motivated - - - Most Motivated); Movement activity (Least Active/Energetic - - - Most Active/Energetic); Thinking activity (Most Slowed Thinking Ever - - - Most Alert/Fast Thinking Ever); Self-esteem (Least Respect For Yourself - - - Most Respect For Yourself); 6) Interest in pleasurable activities (Most interest - - - Least interest); Appettite (Least Desire For Food - - - Most Desire For Food); Anxiety (Worst/Most Anxious - - - Best/Least Anxious); Uncertainty (Worst/Most Uncertain - - - Best/Least Uncertain); Fear (Worst/Most Frightened - - - Best/Least Frightened); and Anger (Worst/Most Angry - - - Best/Least Angry).

More bipolar patients were enrolled than schizophrenia and schizoaffective patients (41 vs. 17 vs. 14) (Table I) specifically to have a larger sample of patients with known affective symptomatology for the purpose of validating the scale. Besides the face validity of using DSM-IV items for its creation, TASS has internal consistency demonstrated by a high degree of correlation between items, as well as external consistency, demonstrated by the high degree of inverse correlation with HAM-D28, a scale measuring depression (FIG. 1c). Moreover, for the purposes of the studies, the scores of the individual items in TASS were tabulated, in a modular endophenotypic fashion or as probes on the PhenoChip, rather than how TASS fits as a classic diagnostic measurement scale.

Data analysis: To determine which phenes had significantly different scores between each disease group and normal controls, a student's t-test for independent samples was used.

This analysis was performed using Statistica (version 6.1). The average value of the raw scores for each phene is used in the t-test calculation. A P-value<0.05 is considered significant (FIG. 1b and Table II). If, however, a conservative Bonferroni correction was applied for multiple testing, as there are 25 probes on the PhenoChip and 3 diagnostic groups, the threshold for significance would change to p<0.00066.

To analyze the relationships between phenes, a standardization of the data may be necessary because of the varying dynamic ranges in which the various psychiatric rating scales measures and neurophysiological hand motor functions are quantified. For example, the HAM-D28 has a score range of 0-82, while the TASS has a range of 0-1100. The Cohen's d effect size (Cohen J. 1988. Statistical power analysis for the behavioral sciences. Hillsdale, N.J.: L. Erlbaum Associates. xxi, 567 p., incorporated herein by reference in its entirety) was used as a method of standardizing scores for the diagnostic groups, in which Cohen's d effect size=M1−M2/σpooled , where M1 is the average score of the disease group for the phene of interest, and M2 is the average score of the control group for that same phene. σpooled is the standard deviation of all of the scores that went into calculating both M1 and M2.

To keep the calculations consistent, a modified Z score (an individual “effect size”) was used to calculate the scores for individual subjects, in which Z score=X1−M2/σpooled, where X1 is the individual score for the phene of interest and M2 the average score of the control group for that same phene. σpooled is the standard deviation of all of the scores that went into calculating both M1 and M2.

Clustering analysis using GeneSpring: GeneSpring (Silicon Genetics, Mountain View, Calif.) the most widely used, commercially available, microarray gene expression analysis software, for the novel use of analyzing and visualizing phenotypic data was adapted for the PhenoChipping. The scores on phenotypic items numbers were used in lieu of the usual use of gene expression intensity numbers. All the subsequent analyses were carried out using the same tools as for gene expression datasets, per the manufacturer's instructions (Silicongenetics). A “genome” (phenome) was created in the program, consisting of the 25 items on the PhenoChip—each item acting as an individual “gene” (phene). The Z scores for each phene in all samples were imported into GeneSpring. No further normalization was applied to the data inside GeneSpring. Two-way hierarchical clustering analysis was applied to the Z scores to investigate relationships between samples and relationships between phenes. Standard correlation is used as the similarity metric. Hierarchical clustering was performed in two ways: clustering by the average scores (effect sizes) of each diagnostic group (3 samples-bipolar (BAD), schizophrenia (SZ), and schizoaffective (SZA) ) (FIG. 3), and clustering across the individual scores (Z scores) of all subjects (104 samples) (FIG. 4).

TABLE I
Demographic data

| | | Controls | Bipolar | Schizophrenia | Schizoaffective |
|---|---|---|---|---|---|
| Number of subjects | | 32 | 41 | 17 | 14 |
| Gender: male:females | | 24:8 | 24:17 | 14:3 | 8:6 |
| Age: | mean years (SD) | 48.4 (8.5) | 44.3 (10.1) | 47.3 (7.6) | 38.6 (7.5) |
| | range | 32-64 | 21-65 | 27-59 | 29-49 |

| | | | | |
|---|---|---|---|---|
| Illness duration: | mean years | 18.3 (11.1) | 22.8 (11.3) | 14.9 (8.7) |
| | (SD) range | 1-47 | 3-39 | 5-34 |

TABLE II
Psychotic disorders compared to normal controls. The effect sizes and
the independent t-test p-values for each phene in a comparison between disease groups and the
normal controls are shown. Numbers in italics/underlined represent phenes that are
significantly increased compared to normal controls and numbers in bold text represent phenes
that are significantly decreased compared to normal controls (Student's t-test, p ≦ 0.05). All
values that have a Cohen's d effect size greater than 0.50 are boxed.

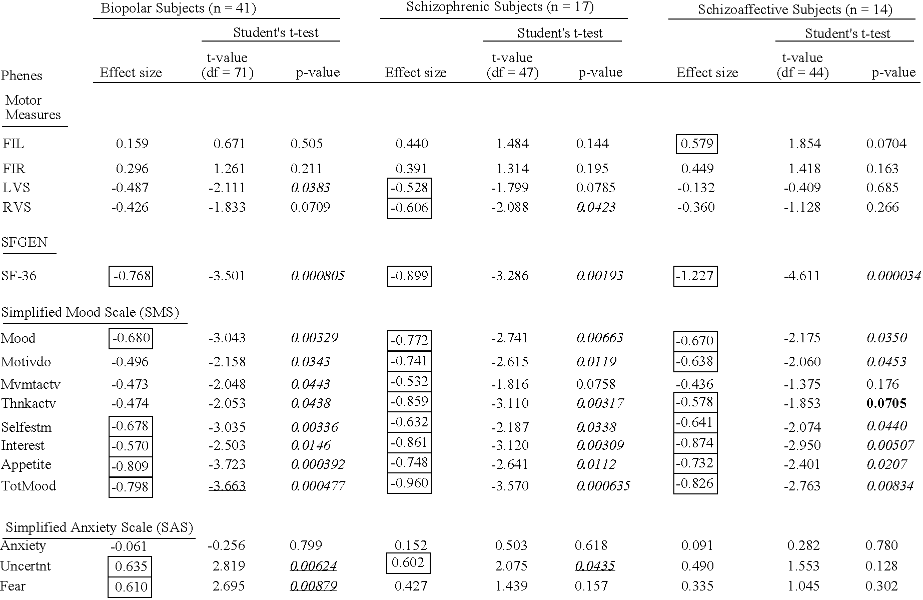

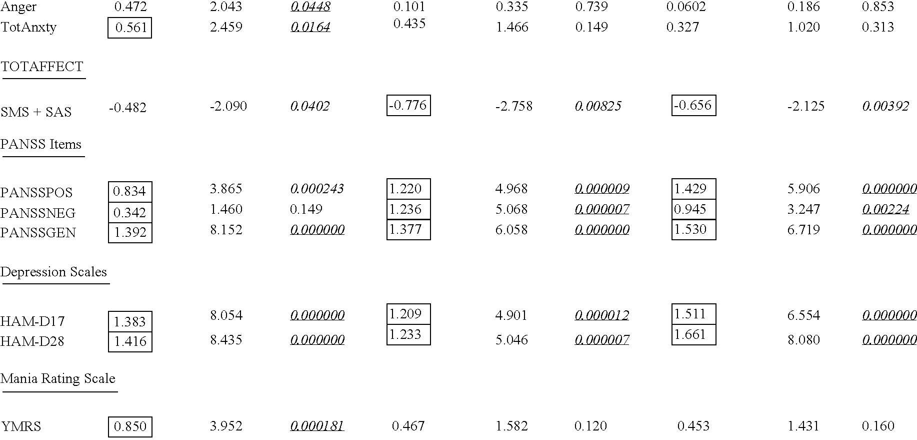

1. A method of systematic phenotypic profiling of one or more individuals with psychiatric disorders to identify empirical relationships between phenotypic items (phenes) and the disorders, the method comprising:
(a) identifying a plurality of psychiatric phenotypic items (phenes), wherein the phenes are quantitatively measured;
(b) assigning a numerical value for one or more of the phenes; and
(c) generating a phenotypic profile for the one or more individuals with psychiatric disorders based on a statistical analysis of the association of the phenes, wherein the phenotypic profile comprises empirical relationships between phenotypic items and the disorders.

2. The method of claim 1, wherein the psychiatric phenotypic items (phenes) are selected from the group consisting of psychiatric rating scales, biomarkers, brain imaging, electroencephalography (EEG), and other neurophysiological data.

3. The method of claim 1, wherein the plurality of phenes are FIL, FIR, LVS, RVS, SFGEN, SF-36, Simplified Mood Scale (SMS), Mood, Motivdo, Mvmtactv, Thnkactv, Selfestm, Interest, Appetite, TotMood, Simplified Anxiety Scale(SAS), Anxiety, Uncertnt, Fear, Anger, TotAnxty, TOTAFFECT, SMS+SAS, PANSS Items, PANSSPOS, PANSSNEG, PANSSGEN, Depression Scales, HAM-D17, HAM-D28, Mania Rating Scale, and YMRS.

4. The method of claim 1, wherein the phenes are derived from measuring Positive and Negative Symptoms Scale (PANSS) (with a positive symptom subscale-PANSSPOS, a negative symptom subscale-PANSSNEG, and a disorganization subscale-PANSSGEN); Hamilton Rating Scale for Depression (HAM-D 17 and HAM-D 28); Young Mania Rating Scale (YMRS); Medical Outcomes Study Short Form-36 (SF-36); Total Affective State Scale (TASS); and neurophysiological motor measures (VS-velocity scaling, and FI-force instability).

5. The method of claim 1, wherein the psychiatric disorders are selected from the group consisting of affective and psychotic disorders.

6. The method of claim 5, wherein the affective disorder is selected from the group consisting of bipolar, depression and anxiety and the psychotic disorder is selected from the group consisting of schizophrenia and schizoaffective disorders.

7. The method of claim 1, wherein the empirical relationships are obtained from a hierarchical clustering analysis.

8. The method of claim 1, wherein the numerial values are normalized using z-scoring.

9. A method of personalizing a psychiatric treatment plan of a subject based on phenotypic profiling, the method comprising:
(a) obtaining a quantitiative psychiatric phenotypic profile of the subject comprising a plurality of psychiatric phenotypic items (phenes);
(b) comparing the phenotypic profile of the subject to one or more reference psychiatric phenotypic profiles of one or more psychiatric disorders; and
(c) selecting a psychiatric treatment plan based on the outcome of the comparison of the phenotypic profile of the patient with the reference psychiatric phenotypic profiles.

10. The method of claim 9, wherein the reference psychiatric phenotypic profiles are obtained from successful psychiatric treatments for psychiatric disorders.

11. The method of claim 9, wherein the plurality of psychiatric phenotypic items (phenes) is selected from the group consisting of psychiatric rating scales, biomarkers, brain imaging, electroencephalography (EEG), and other neurophysiological data.

12. The method of claim 10, wherein the the plurality of psychiatric phenotypic items (phenes) is selected from the group consisting of phenes listed in Table II.

13. The method of claim 9, wherein the reference psychiatric phenotypic profiles comprise psychiatric phenotypic profiles of a plurality of subjects and clinicopathological data selected from the group consisting of age, previous personal and/or familial history of psychiatric disorder, clinical response to psychiatric disorder, and any genetic or biochemical predisposition to psychiatric illness.

14. The method of claim 9, wherein the association between the phenotypic profile of the subject and the reference psychiatric phenotypic profiles is statistically significant.

15. A method of optimizing psychiatric drug discovery or clinical trials, the method comprising:
(a) obtaining quantitative psychiatric phenotypic data for a first set of plurality of subjects in a first clinical trial, wherein the phenotypic data comprises a plurality of psychiatric phenotypic items (phenes);
(b) obtaining clinical trial criteria data from the plurality of the subjects for a psychiatric drug;
(c) generating quantitative psychiatric phenotypic profiles comprising one or more of the psychiatric phenotypic items for one or more of the clinical trial criteria, thereby identifying one or more phenes as surrogate markers for a clinical outcome;
(d) obtaining quantitative psychiatric phenotypic data for a second set of plurality of subjects in a second clinical trial; and
(e) selecting subjects from the second set if the quantitative psychiatric phenotypic data comprises one or more phenes from the first set such that the subjects from the second set are more likely to respond to the psychiatric drug in the second clinical trial.

16. The method of claim 15, wherein the clinical trials criteria are selected from the group consisting of responders/non-responders and side-effects/no side-effects to a psychiatric drug of interest.

17. The method of claim 15, wherein the phenotypic profiles comprise similarity assessed using a hierarchical clustering approach.

18. The method of claim 15, wherein the plurality of psychiatric phenotypic items (phenes) is selected from the group consisting of psychiatric rating scales, biomarkers, brain imaging, and neurophysiological data.

19. The method of claim 15, further comprising sequential enriching of subjects that are more likely to respond to the psychiatric drug based on one or more of phenes or one or more of the clinical trial criteria.

20. The method of claim 15, wherein the quantitative psychiatric phenotypic profiles identify subgroups of subjects associated with a category selected from the group consisting of clinical trial outcome to a new drug, response to a certain existing clinical treatment, and associated with a biomarker or groups of biomarkers.

21. A method of diagnosing a psychiatric disorder in an individual, the method comprising:
(a) performing a systematic phenotypic profiling of the individual, wherein the phenotypic profiling is based on a plurality of quantitative psychiatric phenotypes;
(b) comparing the phenotypic profiling of the individual to one or more reference phenotypic profiles for one or more psychiatric disorders; and
(c) diagnosing the psychiatric disorder if the phenotypic profiling of the individual is statistically similar to one of the reference phenotypic profiles.

22. The method of claim 21, wherein the phenotypic profiling comprises one or more phenes selected from Table II and one or more scoring system selected from the group consisting of Positive and Negative Symptoms Scale (PANSS); a positive symptom subscale (PANSSPOS); a negative symptom subscale (PANSSNEG); a disorganization subscale (PANSSGEN); Hamilton Rating Scale for Depression (HAM-D 17 and HAM-D 28); Young Mania Rating Scale (YMRS); Medical Outcomes Study Short Form-36 (SF-36); Total Affective State Scale (TASS); VS-velocity scaling, and FI-force instability.

23. The method of claim 21, wherein the psychiatric disorder is selected from the group consisting of mood and psychotic disorders.

24. The method of claim 21, wherein the phenotypic profiling is selected from the group consisting of psychiatric rating scales, biomarkers, brain imaging, electroencephalography (EEG), fMRI, PET scans, and other neurophysiological data.

25. The method of claim 21, wherein the phenotypic profiling is based on quantitative measurements obtained through a questionnaire.

26. The method of claim 21, wherein the phenotypic profiling is based on quantitative measurements obtained through a clinical examination.

27. The method of claim 21, wherein the phenotypic profiling is based on quantitative measurements obtained through measurements of biomarkers in bodily fluids.
